(19) United States
(12) Patent Application Publication
(10) Pub. No.: US 2006/0066539 A1
(43) Pub. Date: Mar. 30, 2006

(54) Display device employing capacitive self-emitting element, and method for driving the same

(75) Inventor: Masao Kato, Suita-shi (JP)

Correspondence Address: HAMRE, SCHUMANN, MUELLER & LARSON, P.C., P.O. BOX 2902-0902, MINNEAPOLIS, MN, 55402, US

(73) Assignee: MATSUSHITA TOSHIBA PICTURE DISPLAY CO., LTD., Takatsuki-shi (JP)

(21) Appl. No.: 11/230,776

(22) Filed: Sep. 20, 2005

(30) Foreign Application Priority Data
Sep. 24, 2004 (JP) 2004-277671

(51) Int. Cl. G09G 3/30

(52) U.S. Cl. 345/77

(57) ABSTRACT

A plurality of scan electrodes and data electrodes, and a self-emission layer disposed between the two electrodes are provided, wherein a scan voltage is supplied sequentially to the scan electrodes, and data voltage that corresponds to the display signal data is supplied to the data electrodes. The emission layer of the portions at the intersection between the two electrodes defines pixels in two-dimensional arrangement. A single frame period is divided into a plurality of sub-fields, and the weight of emission luminance is set so that gradation is expressed by a combination of emission luminance in the sub-fields. The scan voltage has a waveform that corresponds to the weight in each sub-field, and the data electrodes are selectively put into on state by the data voltage in accordance with the display signal data. An emission luminance that corresponds to the weight is obtained with a voltage applied to the emission layer of each pixel between the scan electrodes and the data electrodes.

### BACKGROUND OF THE INVENTION

1. Field of the Invention

The present invention relates to self-emitting display devices in which pixels made of capacitive self-emitting elements such as inorganic EL (electro-luminance) elements are arranged in a matrix, forming a display panel, and the pixels are driven selectively to perform a display of an image.

2. Description of Related Art

Inorganic EL elements have a structure in which a light-emission layer that includes a fluorescent layer and a dielectric layer is sandwiched between a pair of electrodes, and emit light in response to a voltage pulse that is applied between that pair of electrodes. The display panel of inorganic EL display devices is made of such inorganic EL elements arranged in a matrix. That is, on a substrate such as glass, a plurality of stripe-shaped electrodes are arranged parallel to one another in the column direction, for example, forming data electrodes, and a plurality of stripe-shaped electrodes are arranged parallel to one another in a row direction that is perpendicular to the data electrodes, forming scan electrodes. An emission layer is interposed between the data electrodes and the scan electrodes, forming inorganic EL elements at the intersection between the electrodes due to this structure of the emission layer sandwiched between the data electrode and the scan electrodes, and thus a passive matrix-type display panel in which numerous display pixels are arranged in a two-dimensional array is achieved.

With inorganic EL elements, however, the emission luminance changes significantly depending on the magnitude of the applied voltage, and thus the luminance changes abruptly as the voltage changes. Consequently, if a voltage gradation method is employed in order to perform a grayscale display, then it is necessary to assign gradations to voltages within a narrow range. Even minor changes in the amplitude of the drive pulse due to discrepancies in the properties of the drive circuits, for example, therefore can cause large changes in the luminance, and thus prevent a precise gradation display from being obtained.

Sub-field driving is known as one grayscale display method for solving this problem (for example, see JP 2004-37495A). Sub-field driving is one type of time axis modulation technique in which a predetermined period (for example, if a moving picture, then one frame, which is a display unit of one image) is partitioned into a plurality of sub-fields, and the pixels are driven to perform a display based on the combination of sub-fields corresponding to the gradation to be displayed. The gradation that is displayed is determined by the ratio of the drive period of the pixels in a single frame, and this ratio is determined by the combination of sub-fields. With this method, as with the voltage gradation method, it is not necessary to prepare as many application voltages for the inorganic EL elements as display gradations, and thus the scale of the circuit of the driver for driving the data electrodes can be reduced. There is also the advantage that it is possible to inhibit drops in display quality due to variations in the properties of the D/A conversion circuit or the op-amp, or nonuniformities among the various line resistors, for example.

With the conventional sub-field driving method set forth in JP 2004-37495A, for example, the luminescence weight of the sub-fields corresponds to the length of the emission drive period in that sub-field. That is, gradation is expressed by combining a plurality of sub-fields having different drive periods.

On the other hand, because inorganic EL elements are capacitive elements, by nature they are not suited for pulse-width gradation methods. That is, when a drive pulse that has a rectangular waveform is applied to the emission layer, the current that contributes to light emission rises up with a sharp peak immediately after the voltage rise, and exhibits the same behavior as the charge current that flows to the capacitors. The current flows for a short time on the order of several μsec, and the voltage that is applied after this current has flowed does not contribute to light emission. Thus, when trying to control the pulse width to perform a grayscale display, it is not possible to obtain a luminance difference between gradations even if the pulse width after the current has flowed is controlled. To obtain a gradation display that has sufficient luminance differences by controlling the pulse width, it is necessary to set a multi-step pulse width in the several μsec time during which charge current is flowing. For this reason, the response speed of the drive circuit and the control precision of the pulse width, for example, are affected by the display characteristics, and when the pulse width changes even slightly, the luminance changes significantly and it is not possible to obtain a precise gradation display.

This problem is not limited to inorganic EL elements, and is shared by all display devices that employ capacitive self-emitting elements.

### SUMMARY OF THE INVENTION

It is an object of the present invention to provide a display device employing capacitive self-emitting elements that uses sub-field driving suited for the properties of capacitive self-emitting elements and that can obtain a stable, precise gradation display, and a method for driving the same.

A display device employing capacitive self-emitting elements according to the present invention includes: a plurality of scan electrodes; a plurality of data electrodes that intersect the scan electrodes; a capacitive self-emission layer disposed between the scan electrodes and the data electrodes; a scan-side drive circuit that sequentially supplies a scan voltage to each of the scan electrodes; a data-side drive circuit that supplies data voltage to each of the data electrodes in accordance with display signal data; and a drive control circuit that controls the scan-side drive circuit and the data-side drive circuit in accordance with signals input from an outside portion, defining a plurality of pixels with the emission layer located at intersections between the scan electrodes and the data electrodes that are arranged in a matrix. A single frame period is divided into a plurality of sub-fields of an equal interval, and a weight of emission luminance in each sub-field is set so that gradation is expressed by a combination of emission luminance values in the sub-fields. For each sub-field, the scan-side drive circuit generates the scan voltage having a waveform that corresponds to the weight in the sub-field, and supplies the generated scan voltage to the scan electrodes. For each sub-field, the data-side drive circuit supplies an on voltage for putting selectively the data electrodes into an on state as the data voltage, in accordance with the display signal data. An emission luminance that corresponds to the weight is obtained with a voltage applied to the emission layer of each pixel between the scan electrodes and the data electrodes, and the voltage applied to the emission layer of each pixel to which the on voltage has not been supplied is set to be a magnitude that does not exceed a threshold for emission.

It should be noted that setting to a magnitude that does not exceed a threshold for emission means that the construction of switching so that emission current does not flow also is included.

A method of driving a display device according to the invention is for driving a display device that employs capacitive self-emitting elements, wherein the display device is provided with a plurality of scan electrodes, a plurality of data electrodes that intersect the scan electrodes, and a capacitive self-emission layer disposed between the scan electrodes and the data electrodes, defining a plurality of pixels with the emission layer located at intersections between the scan electrodes and the data electrodes that are arranged in a matrix; The method includes: dividing a single frame period into a plurality of sub-fields of an equal interval, and setting a weight of emission luminance in each sub-field so that gradation is expressed by a combination of emission luminance values in the sub-fields; supplying sequentially to the scan electrodes with a scan voltage having a waveform that corresponds to the weight for each sub-field; and

supplying to each data electrode an on voltage for putting selectively the data electrode into an on state in each sub-field, in accordance with the display signal data. An emission luminance that corresponds to the weight is obtained with a voltage applied to the emission layer of each pixel between the scan electrodes and the data electrodes, and the voltage applied to the emission layer of each pixel to which the on voltage has not been supplied is set to be a magnitude that does not exceed a threshold for emission.

It should be noted that setting to a magnitude that does not exceed a threshold for emission means that the configuration of switching so that emission current does not flow also is included.

The above-mentioned configurations take advantage of the features of inorganic EL elements, which are a fast response speed and the fact that they output a luminance impulse, to achieve easy driving through equal interval sub-fields and achieve stable, precise gradation displays to be obtained.

### BRIEF DESCRIPTION OF THE DRAWINGS

FIG. 1 is a block diagram that schematically shows the configuration of a display device employing capacitive self-emitting elements according to a first embodiment.

FIG. 2 shows the concept of sub-field driving in the embodiments of the invention.

FIG. 3 is a waveform diagram that shows an example of the gradation voltage in each sub-field in the first embodiment.

FIG. 4 is a circuit diagram showing a resonance circuit in the display device employing capacitive self-emitting elements of FIG. 1.

FIG. 5 is a waveform diagram showing the operation of the resonance circuit of FIG. 4.

FIG. 6 is a circuit diagram showing another example of a resonance circuit in the display device employing capacitive self-emitting elements of FIG. 1.

FIG. 7 is a circuit diagram showing an example of a switch circuit in the display device employing capacitive self-emitting elements of FIG. 1.

FIG. 8 is a waveform diagram showing an example of the gradation voltage in each sub-field according to a second embodiment.

### DETAILED DESCRIPTION OF THE INVENTION

In the display device of the invention, it is possible it adopt a configuration in which the scan voltage has an amplitude that corresponds to the weight in each sub-field.

It is also possible to adopt a configuration in which the scan-side drive circuit generates an AC voltage having a waveform whose frequency is higher than a repeating frequency of a display period of one scan line as the scan voltage, and supplies the generated AC voltage to the scan electrodes, altering its amplitude to a magnitude in accordance with the weight in each sub-field; and the data-side drive circuit generates an AC voltage having a waveform of the same frequency but opposite phase to the AC waveform of the scan voltage, and supplies the generated AC voltage to the data electrodes as the data voltage.

It is also possible to adopt a configuration in which the scan-side drive circuit generates an AC voltage having a waveform whose frequency is higher than a repeating frequency of a display period of one scan line as the scan voltage, and supplies the generated AC voltage to the scan electrodes, altering its frequency in accordance with the weight in the sub-field. In this configuration, it is preferable that the data-side drive circuit generates an AC voltage having a waveform of the same frequency but opposite phase to the AC waveform of the scan voltage, and supplies the generated AC voltage to the data electrodes as the data voltage.

Further, it is also possible for the emission layer to be an inorganic EL emission layer that includes a dielectric layer and a fluorescent layer.

In the method of driving a display device according to the invention, it is possible for the scan voltage to have an amplitude that corresponds to the weight in each sub-field.

It is also possible to adopt a configuration in which an AC voltage having a waveform whose frequency is higher than a repeating frequency of a display period of one scan line is generated as the scan voltage and is supplied to the scan electrodes after its amplitude has been altered in accordance with the weight in the sub-field; and an AC voltage having a waveform of the same frequency but opposite phase to the AC waveform of the scan voltage is generated and supplied to the data electrodes as the data voltage.

It is also possible to adopt a configuration in which an AC voltage having a waveform whose frequency is higher than a repeating frequency of a display period of one scan line is generated and is supplied to the scan electrodes as the scan voltage after its frequency has been altered in accordance with the weight in each sub-field. In this configuration, it is preferable that an AC voltage having a waveform of the same frequency but opposite phase to the AC waveform of the scan voltage is generated and supplied to the data electrodes as the data voltage.

Further, it is also possible for the emission layer to be an inorganic EL emission layer that includes a dielectric layer and a fluorescent layer.

The display device employing capacitive self-emitting elements according to embodiments of the invention is described in detail below with reference to the drawings. The following description presents examples of a display device that employs inorganic EL display elements, but the configuration, for example, set forth below can be adopted similarly for display devices that employ other capacitive self-emitting elements.

### First Embodiment

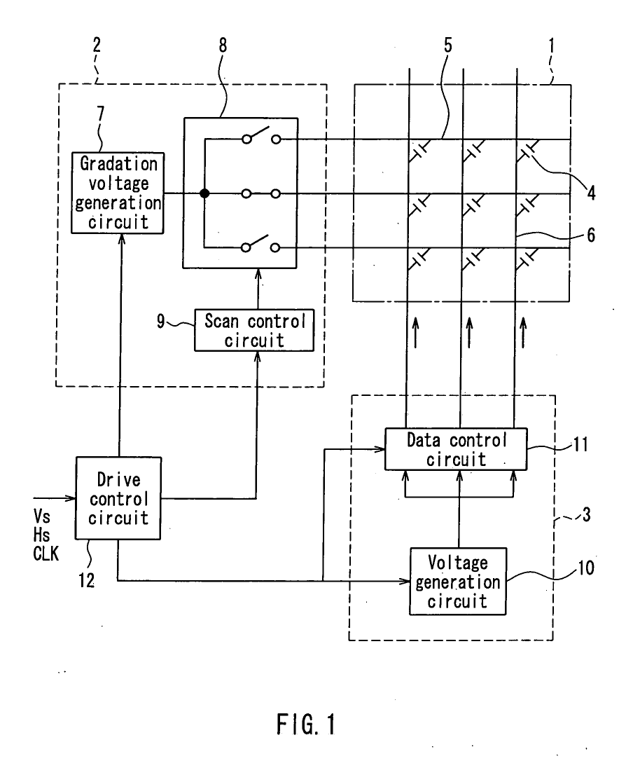

FIG. 1 is a block diagram that schematically shows the configuration of an inorganic EL display device according to a first embodiment of the invention. The inorganic EL display device has an inorganic EL panel 1 that forms a display region, and a scan-side drive circuit 2 and a data-side drive circuit 3 for driving the inorganic EL panel 1.

The inorganic EL panel 1 has a plurality of scan electrodes 5 and a plurality of data electrodes 6, both in lines, that intersect the scan electrodes 5, that are formed sandwiching an inorganic EL emission layer 4 on an insulating substrate (not shown). The inorganic EL emission layer 4 has a well-known structure, and although not shown, it is for example constituted by a fluorescent layer and a dielectric layer formed on at least one surface of the fluorescent layer. The areas of intersection between the scan electrodes 5 and the data electrodes 6 form pixels, and a plurality of pixels are arranged in a two dimensional array, forming a passive matrix-type display panel.

The scan-side drive circuit 2 connected to the scan electrodes 5 sequentially supplies scan voltages. The scan-side drive circuit 2 has a gradation voltage generation circuit 7 that generates gradation voltage as scan voltage, and a switch circuit 8 for selectively connecting the gradation voltage generation circuit 7 to the scan electrodes 5. A scan control circuit 9 controls switching of the switch circuit 8, switching the switch circuit 8 on in a sequential manner, and as a result the gradation voltage generation circuit 7 sequentially supplies scan voltage constituted by gradation voltage to the scan electrodes 5. The data-side drive circuit 3, which is connected to the data electrodes 6, has a voltage generation circuit 10 and a data control circuit 11, and selectively supplies the data voltage generated by the voltage generation circuit 10 to the data electrodes 6 via a data control circuit 11 in correspondence with display signal data. The gradation voltage generated by the gradation voltage generation circuit 7 and the data voltage generated by the voltage generation circuit 10 are described later.

The gradation voltage generation circuit 7, the scan control circuit 9, the voltage generation circuit 10, and the data control circuit 11 operate in response to signals received from a drive control circuit 12. The drive control circuit 12 receives a vertical synchronization signal Vs, a horizontal synchronization signal Hs, a data transfer clock signal CLK, and display signal data D, for example, which are input from the outside. Based on these signals, the drive control circuit 12 generates the necessary signals and supplies those to the scan-side drive circuit 2 and the data-side drive circuit 3. The scan control circuit 9, the data control circuit 3, and the drive control circuit 12 basically have the same configuration as other widely known circuits, and thus will not be described in specific detail here.

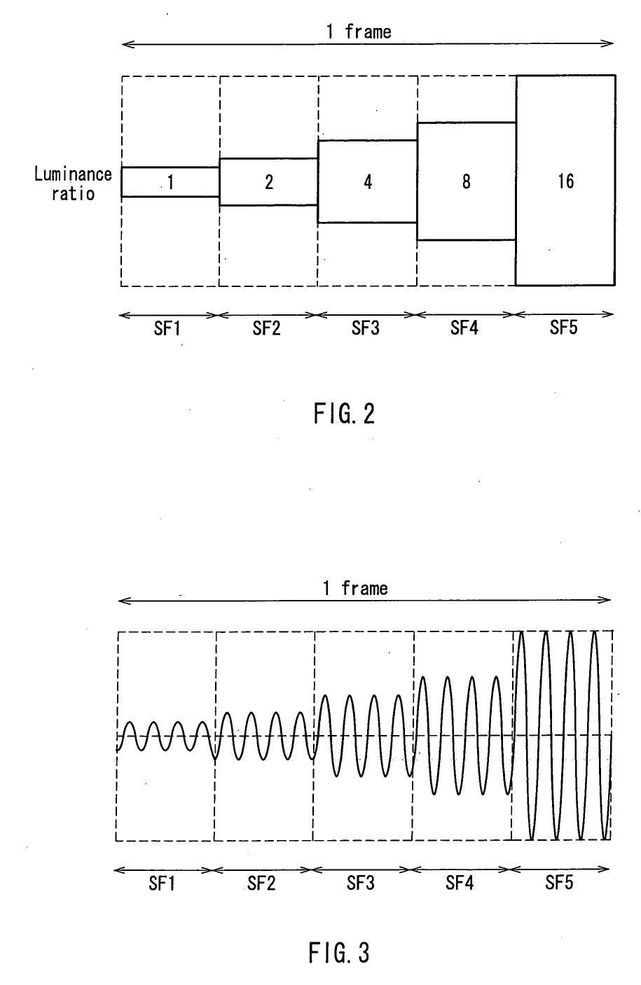

As shown in FIG. 2, in this embodiment the predetermined display period normally is a single frame period that has been separated into a plurality of equal interval sub-fields SF1 to SF5, and the gradation of the display luminance is determined by the combination of the display signal data of each sub-field. For each sub-field, the scan voltage, that is, gradation voltage that is generated by the gradation voltage generation circuit 7, is adjusted to a waveform that gives a luminance corresponding to the weight of that sub-field and supplied to the scan electrodes 5. For example, as shown in FIG. 2, the gradation voltage waveform is generated so that the luminance ratio of the sub-fields SF1 to SF5 is 1:2:4:8:16. The timing at which the gradation voltage waveform that is generated by the gradation voltage generation circuit 7 is switched based on the sub-field and the timing at which the switch circuit 8 is switched in the sub-field by the scan control circuit 9, for example, are controlled based on the signals that are supplied from the drive control circuit 12.

The data voltage that is generated by the voltage generation circuit 10 of the data-side drive circuit 3 is an on voltage for putting the data electrodes 6 into the on state, and is applied selectively to the data electrodes 6 by the data control circuit 11 based on the display signal data. Control by the data control circuit 11 is switched for each display line of the sub-fields SF1 to SF5. A voltage that exceeds an emission threshold is applied to the pixels to which data voltage serving as an on voltage has been supplied, that is, the inorganic EL emission layer 4 of the areas of intersection between the scan electrodes 5 to which gradation voltage has been supplied as scan voltage and the data electrodes 6 to which on voltage has been supplied, based on the potential difference between the scan voltage and the on voltage. Voltage that exceeds the threshold is not applied to the inorganic EL emission layer 4 of pixels in which on voltage has not been applied to the data electrode 6, and thus those pixels do not emit light. In this way, line-sequential scanning for the emission luminance corresponding to the weight in each sub-field is performed for each sub-field.

FIG. 3 shows an example of the gradation voltage waveform in the sub-fields SF1 to SF5. The gradation voltage is an AC waveform with a higher frequency than the repeating frequency of the display period of a single line (for the sake of simplifying the drawing, here the frequency is shown in a low frequency region). The frequency is the same for the sub-fields SF1 to SF5, but the amplitude is set to correspond to the weight of the luminance of that sub-field. The reason for setting such an AC waveform is discussed below.

That is, because the inorganic EL elements are capacitive elements, the current that contributes to light emission when the drive voltage is applied to the emission layer rises up with a sharp peak immediately after the voltage rises, and the charge current that flows to the capacitors exhibits the same behavior. The current flows for a short time on the order of several μsec, and the voltage that is applied after this current has flowed does not contribute to light emission. In order words, it is not possible to obtain continuous light emission if a DC voltage is applied as the drive voltage. Thus, the inorganic EL display device uses a drive method in which so-called frame (or field; hereinafter referred to simply as “frame”) inversion driving is employed to invert the polarity of the voltage that is applied to the emission layer for each frame. Driving with an AC voltage like that of this embodiment allows inverse driving to be performed within each sub-field. Further, as discussed later, doing this allows a simple circuit configuration that employs a resonance circuit to be achieved.

A scan voltage made of a gradation voltage such as that shown in FIG. 3 is supplied to the scan electrodes 5, and an AC waveform having the same frequency but the opposite phase as the AC waveform of the scan voltage is applied to the data electrodes 6 as data voltage according to the display signal data. In this case, it is also possible for the amplitude of the data voltage to be constant across all of the sub-fields. Alternatively, it is also possible to adopt a configuration in which the amplitude of the data voltage is different for each sub-field, so that the gradation of the each sub-field is determined based on the combination of the data voltage and the scan voltage that is applied to the scan electrodes 5.

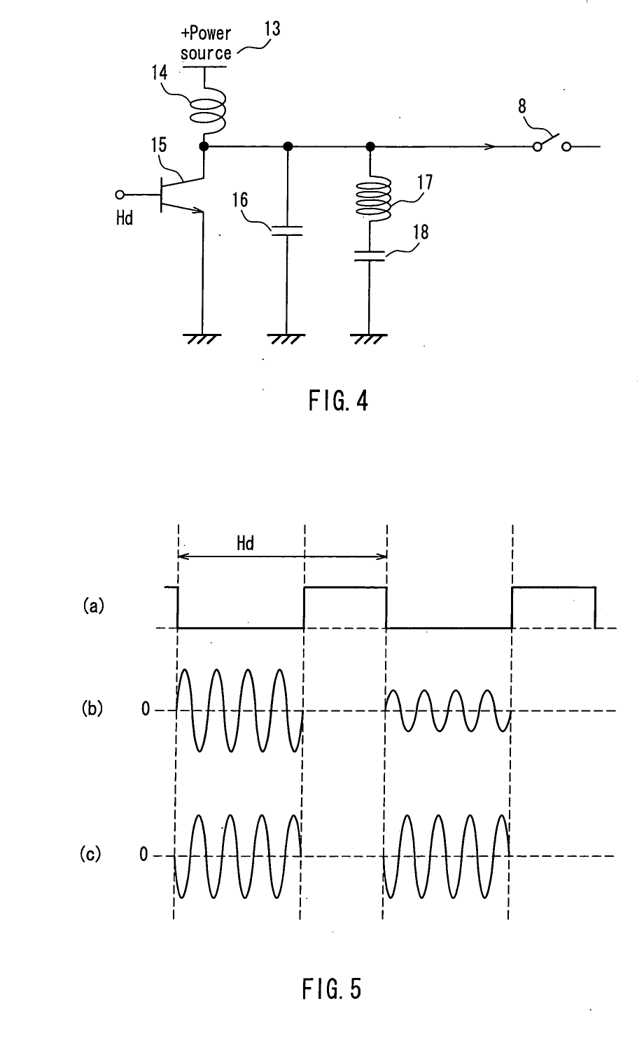

To generate the scan voltage, which is an AC gradation voltage, or the AC data voltage, it is possible to use the resonance circuit configuration shown in FIG. 4, for example. This resonance circuit includes a first coil 14 and a switching element 15 that are connected in series between a power source 13 and a ground potential. One terminal of a first capacitor 16 is connected to the point of connection between the first coil 14 and the switching element 15. The other terminal of the first capacitor 16 is grounded. A second coil 17 and a second capacitor 18 are connected to one another in series, and are connected in parallel to the first capacitor 16. A horizontal scan line synchronization signal Hd that is created based on the horizontal synchronization signal Hs is input to the switching element 15. The AC voltage that is obtained due to the resonance generated by the first capacitor 16 and the second coil 17 is supplied to the switch circuit 8 from the point of connection between the first capacitor 16 and the second coil 17.

The operation of the resonance circuit of FIG. 4 is shown in FIG. 5. FIG. 5(a) shows the horizontal scan line synchronization signal Hd that is input to the switching element 15. The horizontal scan line synchronization signal Hd is created based on the horizontal synchronization signal Hs that is supplied from the outside, and is a synchronization signal that corresponds to a single horizontal line of a display scan. FIG. 5(b) shows the AC voltage waveform that is output. The switching element 15 is off during the period that the signal Hd is low level, and as a result power is supplied to the resonance portion constituted by the first capacitor 16 and the second coil 17 and AC voltage is output. The switching element 15 is on during the period that the signal Hd is high level, and because power is not supplied to the resonance portion, the output of the AC voltage is stopped.

As shown in the drawing, the frequency of the voltage waveform that is output by this resonance circuit is higher than the frequency of the horizontal scan line synchronization signal Hd, that is, the repeating frequency of the display period of one scan line. Consequently, a plurality of AC waveforms fall within the horizontal scan period. In practice, this frequency can be set to a frequency in the range of 1 kHz to 100 kHz. The amplitude of the scan voltage that is supplied to the scan electrodes 5 changes depending on the weight of the sub-field, as shown in FIG. 5(b), but the data voltage that is supplied to the data electrodes 6 stays constant even if the sub-field changes, as shown in FIG. 5(c). Further, the data voltage shown in FIG. 5(c) is opposite in phase to the scan voltage shown in FIG. 5(b).

For example, in the resonance circuit of FIG. 4, power source modulation can be performed if the voltage of the power source 13 is modulated by the switching element, for example, and by doing this, the emission luminance of the inorganic EL emission layer 4 of each pixel can be changed in accordance with the weight in each sub-field.

As discussed above, using the resonance circuit of FIG. 4 allows both positive and negative polarity drive voltages to be generated with a positive polarity power source, thus simplifying the configuration of the circuit. This is advantageous for achieving a compact device and reducing costs. Further, if the resonance circuits used for the gradation voltage generation circuit 7 and the voltage generation circuit 10 have the same configuration, then the non-symmetrical nature of the DC component of the AC voltage that is generated is cancelled out, and this allows the DC voltage that is applied to the inorganic EL emission layer 4 to be reduced. This consequently is beneficial for increasing the life of the inorganic EL emission layer.

With the resonance circuit of FIG. 4, to generate a AC voltage waveform of 90 kHz and 300 Vp-0 when the power source voltage is 35V and the signal Hd is 30 μs, it is possible for the inductance of the first coil 14 to be 6 mH, the inductance of the second coil 17 to be 0.5 mH, the capacitance of the first capacitor 16 to be 6600 pF, and the capacitance of the second capacitor 18 to be 220 nF. To generate a 1 kHz, 300 Vp-0 AC voltage waveform with a signal Hd of 10 ms, it is possible for the inductance of the first coil 14 to be 30 mH, the inductance of the second coil 17 to be 3 mH, the capacitance of the first capacitor 16 to be 8.5 μF, and the capacitance of the second capacitor 18 to be 220 μF.

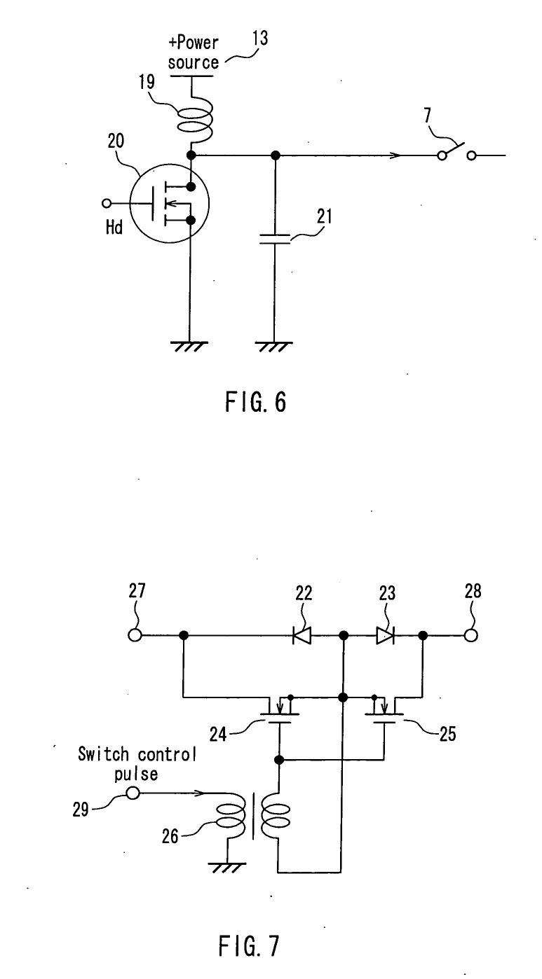

FIG. 6 shows an example of another configuration of the resonance circuit that is used for the gradation voltage generation circuit 7 or the voltage generation circuit 10. In contrast to the resonance circuit of FIG. 4, which uses two coils, this resonance circuit uses a single coil 19. The coil 19 is connected in series to a switching element 20, which is a FET, between the power source 13 and the ground potential. A capacitor 21 is connected in parallel to the switching element 20. The AC voltage that is obtained with the resonance that is generated by the coil 19 and the capacitor 21 is supplied to the switch circuit 8 from the point of connection between the capacitor 21 and the coil 19.

The operation of this resonance circuit is basically the same as the operation shown in FIG. 5. That is, a signal Hd such as that shown in FIG. 5(a) is input to the switching element 20. When signal Hd is low level, the switching element 20 is off, and thus power is supplied to the capacitor 21 and AC voltage is output. The switching element 20 is on during the period that the signal Hd is high level, and as a result power is not supplied to the capacitor 21, so that the output of AC voltage is stopped.

The resonance circuit using two coils that is shown in FIG. 4 has the advantage that the inductance of the first coil 14 that is connected to the power source can be made large, and this allows the flow of DC current into the switching element 15 to be inhibited and power consumption to be reduced. In contrast, the resonance circuit of FIG. 6 has the advantage of a simpler configuration with fewer structural components, which allows costs to be reduced.

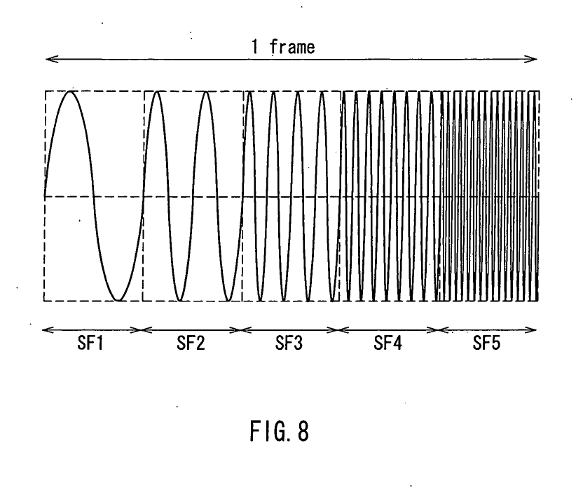

FIG. 7 shows an example of the configuration of the switch circuit 8 of FIG. 1. The switch circuit 8 is made of two diodes 22 and 23, two FETs 24 and 25, and a pulse transformer 26. The diodes 22 and 23 are connected in series so that they are opposite polarity, and the FETs 24 and 25 are connected in parallel to the diodes 22 and 23, respectively. The ends of the series circuit of the diodes 22 and 23 are an input terminal 27 and an output terminal 28 of this switch circuit. The output of the gradation voltage generation circuit 7 is supplied to the input terminal 27, and the output terminal 28 is connected to the scan electrodes 5. Switch control pulses for line-sequential scanning are supplied from the scan control circuit 9 to a primary side input terminal 29 of the pulse transformer 26. One end of the secondary side of the pulse transformer 26 is connected to the gates of the FETs 24 and 25, and its other end is connected to the point of connection between the diodes 22 and 23 and the point of connection between the FETs 24 and 25. In place of the pulse transformer 26, it is also possible to achieve this circuit using a photocoupler.

### Second Embodiment

An inorganic EL display device according to a second embodiment is described with reference to FIG. 8. The basic configuration of the inorganic EL display device is the same as that of the device of FIG. 1. FIG. 8 shows an example of the scan voltage, that is, the gradation voltage waveform, that is supplied in sub-fields SF1 to SF5 when driving the inorganic EL display device of this embodiment. This gradation voltage is an AC waveform having a higher frequency than the repeating frequency of the display period of one scan line. This AC waveform has constant amplitude over sub-fields SF1 to SF5, but its frequency is set to a height that corresponds to the weight of the luminance in each sub-field. For example, the frequency in sub-field SF5 is set to a height that is 16 times the height of the frequency in sub-field SF1. The higher the frequency, the higher the frequency of emission of light in one sub-field and the greater the amount of light emitted.

The scan voltage made of this gradation voltage is generated by the gradation voltage generation circuit 7 and supplied to the scan electrodes 5, and an AC waveform having opposite phase but the same frequency as the AC waveform of the scan voltage is applied to the data electrodes 6 as data voltage by the voltage generation circuit 10 according to the display signal data. In this case, it is also possible for the amplitude of the data voltage to be constant over all sub-fields.

Like in the first embodiment, it is possible to use a resonance circuit such as that shown in FIG. 4 and FIG. 6 for the gradation voltage generation circuit 7 and the voltage generation circuit 10. For example, with the resonance circuit shown in FIG. 4, if the capacitance of the second capacitor 18 is made variable, then the frequency of the AV voltage that is output can be modulated in accordance with the capacitance.

The frequency of the AC waveform that is generated by the gradation voltage generation circuit 7 can be set as follows for example. In a case where line-sequencing scanning is used and one field is made of five sub-fields of 120 lines at 60 Hz, the sub-field frequencies are a minimum frequency of 36 kHz in sub-field SF1, then 72 kHz, 144 kHz, 288 kHz, and 576 kHz, in that order. In the case of 50 lines, the sub-field frequencies are a minimum frequency of 15 kHz in sub-field SF1, and then 30 kHz, 60 kHz, 120 kHz, and 240 kHz, in that order. In the case of plane-sequential scanning, the sub-field frequencies are a minimum frequency of 1 kHz in sub-field SF1, then 2 kHz, 4 kHz, 8 kHz, and 16 kHz, in that order.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A display device that employs capacitive self-emitting elements, comprising:
a plurality of scan electrodes;
a plurality of data electrodes that intersect the scan electrodes;
a capacitive self-emission layer disposed between the scan electrodes and the data electrodes;
a scan-side drive circuit that sequentially supplies a scan voltage to each of the scan electrodes;
a data-side drive circuit that supplies data voltage to each of the data electrodes in accordance with display signal data; and
a drive control circuit that controls the scan-side drive circuit and the data-side drive circuit in accordance with signals input from an outside portion,
defining a plurality of pixels with the emission layer located at intersections between the scan electrodes and the data electrodes that are arranged in a matrix,
wherein a single frame period is divided into a plurality of sub-fields of an equal interval, and a weight of emission luminance in each sub-field is set so that gradation is expressed by a combination of emission luminance values in the sub-fields;
for each sub-field, the scan-side drive circuit generates the scan voltage having a waveform that corresponds to the weight in the sub-field, and supplies the generated scan voltage to the scan electrodes; and
for each sub-field, the data-side drive circuit supplies an on voltage for putting selectively the data electrodes into an on state as the data voltage, in accordance with the display signal data,
whereby an emission luminance that corresponds to the weight is obtained with a voltage applied to the emission layer of each pixel between the scan electrodes and the data electrodes, and the voltage applied to the emission layer of each pixel to which the on voltage has not been supplied is set to be a magnitude that does not exceed a threshold for emission.

2. The display device that employs capacitive self-emitting elements according to claim 1,
wherein the scan voltage has an amplitude that corresponds to the weight in each sub-field.

3. The display device that employs capacitive self-emitting elements according to claim 2,
wherein the scan-side drive circuit generates an AC voltage having a waveform whose frequency is higher than a repeating frequency of a display period of one scan line as the scan voltage, and supplies the generated AC voltage to the scan electrodes, altering its amplitude to a magnitude in accordance with the weight in each sub-field; and
the data-side drive circuit generates an AC voltage having a waveform of the same frequency but opposite phase to the AC waveform of the scan voltage, and supplies the generated AC voltage to the data electrodes as the data voltage.

4. The display device that employs capacitive self-emitting elements according to claim 1,
wherein the scan-side drive circuit generates an AC voltage having a waveform whose frequency is higher than a repeating frequency of a display period of one scan line as the scan voltage, and supplies the generated AC voltage to the scan electrodes, altering its frequency in accordance with the weight in the sub-field.

5. The display device that employs capacitive self-emitting elements according to claim 4,
wherein the data-side drive circuit generates an AC voltage having a waveform of the same frequency but opposite phase to the AC waveform of the scan voltage, and supplies the generated AC voltage to the data electrodes as the data voltage.

6. The display device that employs capacitive self-emitting elements according to claim 1,
wherein the emission layer is an inorganic EL emission layer that includes a dielectric layer and a fluorescent layer.

7. A method of driving a display device that employs capacitive self-emitting elements, wherein the display device is provided with a plurality of scan electrodes, a plurality of data electrodes that intersect the scan electrodes, and a capacitive self-emission layer disposed between the scan electrodes and the data electrodes, defining a plurality of pixels with the emission layer located at intersections between the scan electrodes and the data electrodes that are arranged in a matrix,
the method comprising:
dividing a single frame period into a plurality of sub-fields of an equal interval, and setting a weight of emission luminance in each sub-field so that gradation is expressed by a combination of emission luminance values in the sub-fields;
supplying sequentially to the scan electrodes with a scan voltage having a waveform that corresponds to the weight for each sub-field; and
supplying to each data electrode an on voltage for putting selectively the data electrode into an on state in each sub-field, in accordance with the display signal data,
whereby an emission luminance that corresponds to the weight is obtained with a voltage applied to the emission layer of each pixel between the scan electrodes and the data electrodes, and the voltage applied to the emission layer of each pixel to which the on voltage has not been supplied is set to be a magnitude that does not exceed a threshold for emission.

8. The method of driving a display device that employs capacitive self-emitting elements according to claim 7,
wherein the scan voltage has an amplitude that corresponds to the weight in each sub-field.

9. The method of driving a display device that employs capacitive self-emitting elements according to claim 8,
wherein an AC voltage having a waveform whose frequency is higher than a repeating frequency of a display period of one scan line is generated as the scan voltage and is supplied to the scan electrodes after its amplitude has been altered in accordance with the weight in the sub-field; and
an AC voltage having a waveform of the same frequency but opposite phase to the AC waveform of the scan voltage is generated and supplied to the data electrodes as the data voltage.

10. The method of driving a display device that employs capacitive self-emitting elements according to claim 7,
wherein an AC voltage having a waveform whose frequency is higher than a repeating frequency of a display period of one scan line is generated and is supplied to the scan electrodes as the scan voltage after its frequency has been altered in accordance with the weight in each sub-field.

11. The method of driving a display device that employs capacitive self-emitting elements according to claim 10,
wherein an AC voltage having a waveform of the same frequency but opposite phase to the AC waveform of the scan voltage is generated and supplied to the data electrodes as the data voltage.

12. The method of driving a display device that employs capacitive self-emitting elements according to claim 7,
wherein the emission layer is an inorganic EL emission layer that includes a dielectric layer and a fluorescent layer.
